(19) United States
(12) Patent Application Publication
(10) Pub. No.: US 2013/0304528 A1
(43) Pub. Date: Nov. 14, 2013

(54) MANAGEMENT DEVICE AND MANAGEMENT METHOD

(71) Applicants: Takayuki Natsume, Minato-ku (JP); Kengo Shinoda, Minato-ku (JP); Takuya Hashimoto, Minato-ku (JP)

(72) Inventors: Takayuki Natsume, Minato-ku (JP); Kengo Shinoda, Minato-ku (JP); Takuya Hashimoto, Minato-ku (JP)

(73) Assignee: KONAMI DIGITAL ENTERTAINMENT CO., LTD., Minato-ku, Tokyo (JP)

(21) Appl. No.: 13/981,240

(22) PCT Filed: May 30, 2012
(86) PCT No.: PCT/JP2012/063863

§ 371 Date: Jul. 23, 2013

(30) Foreign Application Priority Data
May 31, 2011 (JP) 2011-121779

(51) Int. Cl. G06Q 10/02

(52) U.S. Cl. CPC G06Q 10/02
USPC 705/5

(57) ABSTRACT

A management device provides to members a solicitation page to solicit reservations of a target for use that is jointly used by plural members via the Internet 1. The member can make a hosting application to host the solicitation for the reservations of the target for use by a communication device. It is possible for a hosting member to change solicitation conditions and to increase or reduce prices until the end of a solicitation period. A member whose reservation application is approved can reduce the price for a reservation space which is not reserved yet, using the communication device. The changes in the solicitation conditions and the price are reflected on the solicitation page and posted on the Internet by the management device.

### TECHNICAL FIELD

The present invention relates to a technology such as a reservation support system that is provided on a general membership service site and an SNS (Social Networking Service) site.

### BACKGROUND ART

At golf courses, users form a party and play golf in a party unit. A reservation of a target for use that is jointly used by multiple people may be finalized under the condition that the reservation is made by the multiple people. It is often difficult to make a reservation for playing golf because not all acquaintances who wish to make the reservation are available on the day to make the reservation.

Therefore, a system that helps to make the reservation in the party unit by making a group of plural strangers is known. According to this system, each reserver makes a reservation application to reservation spaces prepared in advance at a reservation site on the Internet, and the reservation is finalized when the total number of the reservers reaches a predetermined number (refer to Patent Document 1).

### CITATION LIST

### Patent Document

Patent Document 1: Japanese Patent Application Laid-Open Publication No. 2011-53814

### SUMMARY OF INVENTION

### Technical Problem

However, according to such a conventional system, it is not possible for the reservers to take active actions in order to finalize the reservation. As a result, the number of the reservers does not reach the predetermined number and the making of the reservation often ends in failure.

### Solution to Problem

Hereinafter, means to be adopted by the present invention in order to solve the above-described problems will be explained.

A management device according to the present invention is to provide information to solicit reservations of a target for use that is jointly used by plural members via a communication network, and to finalize the reservations as one group reservation by receiving plural applications with regard to the reservations of the target for use made by the plural members. The management device includes a solicitation information providing unit that provides via the communication network reservation space information including plural reservation spaces corresponding to a number of people who can use the target for use and price information elements respectively set for the plural reservation spaces; a hosting application accepting unit that, when accepting a hosting application by receiving hosting application information showing the hosting application offering to host solicitation for the reservations of the target for use from a communication device of the member, changes the reservation space which is specified by the hosting application information and which is in a non-reserved state into a reserved state as a host reservation space; a price changing unit that, when accepting a changing application by receiving changing application information showing the changing application to change the price set for the reservation space from the communication device of a hosting member who is a member whose hosting application is accepted, updates the price information element set for the reservation space in the non-reserved state, according to the price information element specified by the changing application information; a reservation application accepting unit that, when approving a reservation application by receiving reservation application information showing the reservation application offering to reserve the target for use from the communication device of the member, changes the reservation space, which is specified by the reservation application information and which is in the non-reserved state, into the reserved state; and a reservation finalizing unit that, when all the reservation spaces are in the reserved state, finalizes the reservations as one group reservation.

Any kind of a condition may be adopted as a condition for “approving the reservation application”, and the approval may be made on a condition that the reservation application information is received, or the approval may be made on a condition that solicitation conditions are fulfilled by the reservation application. In these cases, approval by the hosting member is not necessary. Alternatively, the reservation application may be approved under the condition that the approval is made by the hosting member.

According to the above-described management device, it is preferable that, when accepting the changing application of the hosting member to reduce or increase the price for the reservation space in the non-reserved state, the price changing unit changes the price information element of the host reservation space while maintaining a sum total of the prices of all the reservation spaces constant.

In the above-described management device, when the changing application shows that the price for the reservation space in the non-reserved state is reduced, the price changing unit may make it a condition for accepting the changing application that the hosting member pays electronic points corresponding to a reduction amount of the price.

When the reservation is not finally made, the electronic points may be paid back from the management device to the hosting member.

In the above-described management device, when accepting a price reducing application by receiving price reducing application information showing the price reducing application to reduce the price set for the reservation space in the non-reserved state by a predetermined amount from the member whose reservation application is approved, the price changing unit may reduce by the predetermined amount the price information element set for the reservation space which is specified by the price reducing application information and which is in the non-reserved state, and may increase by the predetermined amount the price information element set for the reservation space which is reserved by the member whose reservation application is approved.

In this case, the price changing unit may make it a condition for accepting the price reducing application that electronic points corresponding to the predetermined amount be paid.

According to the above-described management device, it is preferable that the changing application information or the price reducing application information independently specifies the price information element corresponding to the reservation space which is in the non-reserved state included in the reservation space information, and that the price changing unit changes the price information element corresponding to the reservation space which is independently specified.

According to the above-described management device, it is preferable that the hosting application information or the changing application information include solicitation conditions of the reservation spaces in the non-reserved state, and the solicitation information providing unit provides the solicitation conditions shown in the hosting application information or the changing application information via the communication network.

According to the above-described management device, it is preferable that the hosting application information include identification information of the member offering to host the solicitation for the reservations of the target for use, that the reservation application information include the identification information of the member offering to reserve the target for use, and that the solicitation information providing unit read out profile information associated with the identification information of the hosting member, from a member database in which the identification information identifying the member and the profile information showing a profile of the member are associated with each other and stored, to provide the profile information associated with the host reservation space to the member via the communication network, and reads out the profile information associated with the identification information of the member whose reservation application is approved from the member database, to provide the profile information associated with the reservation space which is specified by the reservation application information to the member via the communication network.

According to the above-described management device, it is preferable that the reservation application accepting unit be able to accept plural reservation applications for one reservation space, that the solicitation information providing unit provide the member with the profile information of the member whose reservation application is accepted in association with the reservation space, via the communication network, and that, when receiving approval or disapproval information showing approval or disapproval of the reservation application corresponding to the reservation space from the hosting member via the communication network, in a case in which the approval or disapproval information shows that the reservation application is approved, the reservation application accepting unit associates the reservation space only with the reservation application which is approved and changes the reservation space into the reserved state.

When the plural reservation applications are made for one reservation space, the hosting member can browse the profiles of the members whose reservation applications are accepted, so as to make a decision whether to choose a person to approve or to decline all the members.

A management method according to the present invention is to provide information to solicit reservations of a target for use that is jointly used by plural members via a communication network, and to finalize the reservations as one group reservation by receiving plural applications with regard to the reservations of the target for use made by the plural members. The management method includes a step of providing via the communication network reservation space information including plural reservation spaces corresponding to a number of people who can use the target for use and price information elements respectively set for the plural reservation spaces; a step of, when accepting a hosting application by receiving hosting application information showing the hosting application offering to host solicitation for the reservations of the target for use from a communication device of the member, changing the reservation space which is specified by the hosting application information and which is in a non-reserved state into a reserved state as a host reservation space; a step of, when accepting a changing application by receiving changing application information showing the changing application to change the price set for the reservation space from the communication device of a hosting member who is a member whose hosting application is accepted, updating the price information element set for the reservation space in the non-reserved state, according to the price information element specified by the changing application information; a step of, when approving a reservation application by receiving reservation application information showing the reservation application offering to reserve the target for use from the communication device of the member, changing the reservation space which is specified by the reservation application information and which is in the non-reserved state into the reserved state; and a step of, when all the reservation spaces are in the reserved state, finalizing the reservations as one group reservation.

### BRIEF DESCRIPTION OF DRAWINGS

FIG. 1 is a block diagram of a service providing system according to an embodiment of the present invention;

FIG. 2 is a block diagram showing the structure of a management device;

FIG. 3 is an explanatory view showing an example of data structure of a member database;

FIG. 4 is an explanatory view for explaining an example of the sequence of a solicitation request;

FIG. 5 is an explanatory view showing an example of a solicitation page;

FIG. 6 is an explanatory view for explaining an example of the sequence of a hosting application, a changing application of a hosting member, and a reservation application;

FIG. 7 is an explanatory view showing an example of the solicitation page after the hosting application is accepted;

FIG. 8 is an explanatory view showing an example of the solicitation page after the changing application;

FIG. 9 is an explanatory view showing an example of the solicitation page after the reservation application is accepted;

FIG. 10 is an explanatory view showing an example of a management page;

FIG. 11 is an explanatory view showing an example of the solicitation page after the reservation application is approved;

FIG. 12 is an explanatory view for explaining an example of the sequence of a price reducing application and a group reservation finalization notice; and

FIG. 13 is an explanatory view showing an example of the solicitation page after the price reducing application is made.

### DESCRIPTION OF EMBODIMENTS

### 1. Structure of Reservation Support System

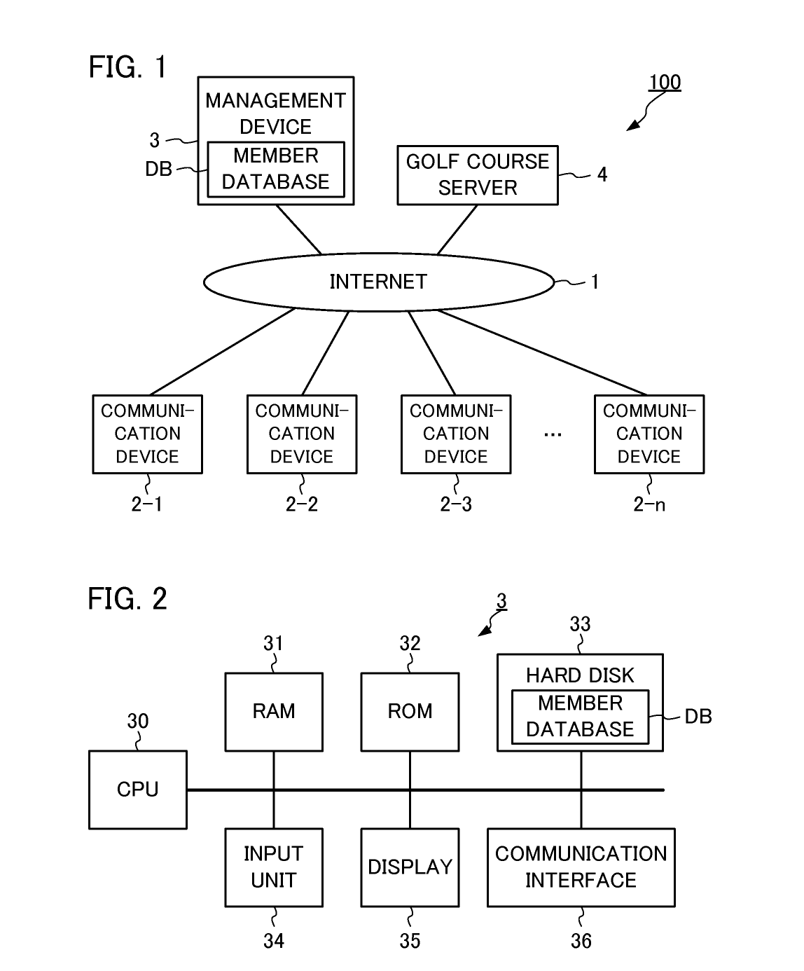

FIG. 1 is a block diagram of a reservation support system 100 according to an embodiment of the present invention. This reservation support system 100 is to support plural members to jointly make a reservation of a target for use. Here, a reservation support system of a golf course targeted for members of an SNS will be explained as an example of the reservation support system.

The reservation support system 100 includes communication devices 2-1, 2-2, 2-3, . . . 2-n of the members, a management device 3 managing reservations of the target for use, a golf course server 4, and the Internet 1 serving as a communication network. The communication devices 2-1 to 2-n of the members that have a browser function and an e-mail function are able to perform communication via the Internet 1, and they may be personal computers and cellular phones. The golf course server 4 is a server that is operated by a manager of a golf course and provides the management device 3 with information regarding solicitation for the reservations of the target for use.

The management device 3 provides the members of the SNS with the information regarding the solicitation for the reservations of the various targets for use that are targeted for the members of the SNS. The targets for use include the golf courses to be jointly used by the plural members, products to be jointly purchased by the plural members and the like. The reservation support system supports the reservation of the golf course at which the plural members play golf jointly, the joint purchase of the products by the plural members, and the like.

FIG. 2 shows the structure of the management device. As shown in the drawing, the management device 3 includes a CPU (Central Processing Unit) 30 to control the device as a whole, a RAM (Random Access Memory) 31 to function as a working space of the CPU 30, a ROM (Read Only Memory) 32 to store a boot program and the like, a hard disk 33 to store various programs and data, an input unit 34 including a keyboard, a mouse or the like, a display 35 to display an image, and a communication interface to perform communication with an external device via the Internet 1.

The hard disk 33 stores a member database DB. The management device 3 may be formed by plural servers, and a server to manage the reservations of the target for use and a server to provide the member database DB may be provided separately.

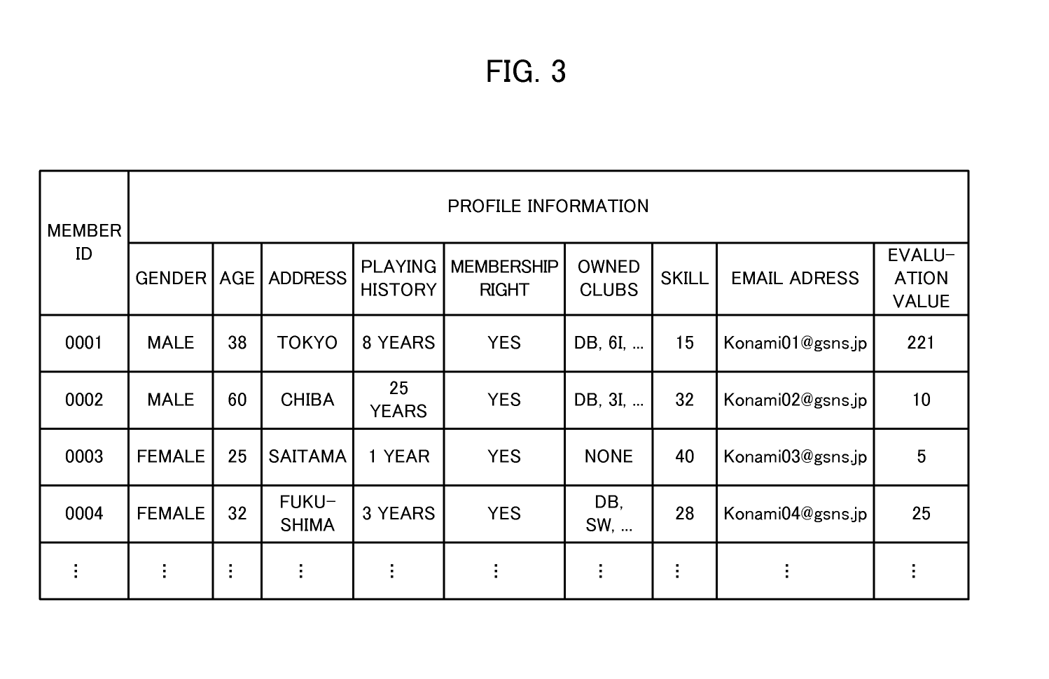

FIG. 3 shows a part of a data structure of data stored in the member database DB. As shown in the drawing, member IDs as information elements for uniquely identifying the members (identification information) and profile information elements are associated with each other and stored in the member database DB. The profile information elements such as gender, age, address, golf playing history, with or without a membership right, owned clubs, skill, email address and an evaluation value are respectively associated with the member ID and stored. The membership right means a golf club membership right. The skill means a handicap in golf. Furthermore, the evaluation value is an accumulated value of values evaluated by the members who played golf together with regard to manners and likability of an evaluation target after playing golf. For example, the evaluation is made by scoring “very good” as “2”, “good” as “1”, “average” as “0”, “bad” as “−1” and “very bad” as “−2”.

### 2. Operation of Service Providing System

Next, the operation of a service providing system 100 will be explained by dividing the operation into a solicitation request, a hosting application, a changing application by a hosting member, a price reducing application by a participating member, and a reservation finalization notice.

### 2-1. Solicitation Request

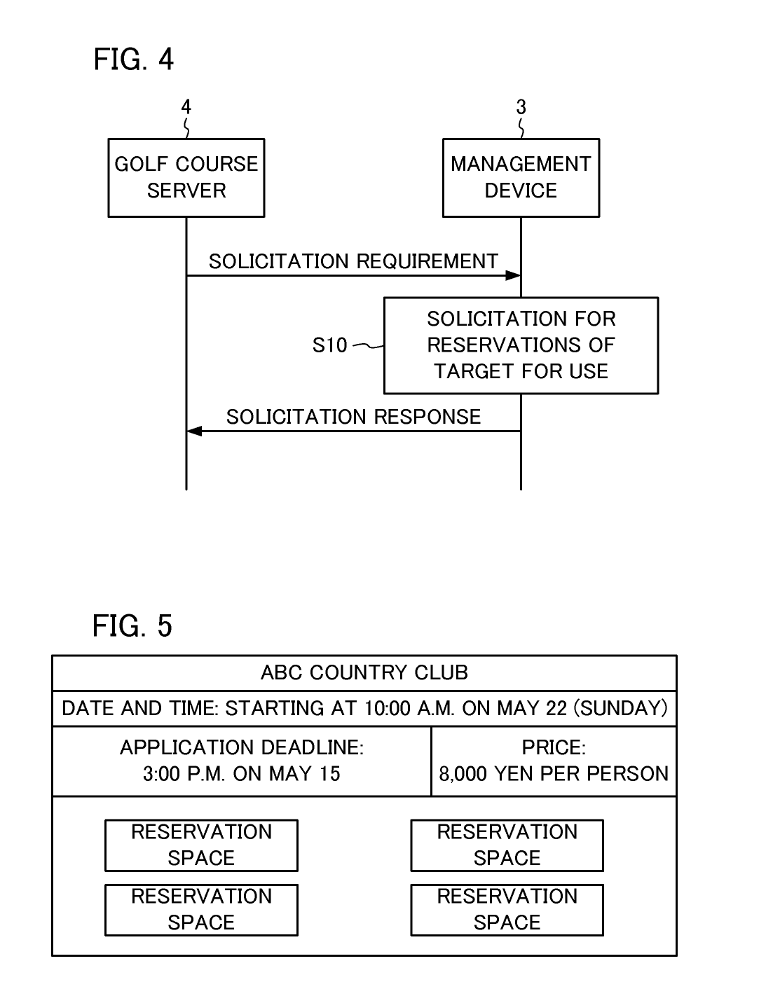

FIG. 4 shows the sequence of the solicitation request. As shown in the drawing, when the golf course server 4 transmits a solicitation requirement to the management device 3, the management device 3 provides via the Internet 1 information to solicit reservations of the target for use that is jointly used by plural members, based on the solicitation requirement (S10). In this case, the provision of the information may be limited to the members, or may not be limited to the members. When it is not limited to the members, the contents of the service are revealed to non-members, which may motivate them to register as members.

The solicitation requirement includes solicitation information showing a golf course name, date and time, an application deadline, the number of people and the price per person. When the golf course name shown in the solicitation requirement is “ABC Country Club”, the date and time is “starting at 10:00 a.m. on May 22 (Sunday)”, the application deadline is “3:00 p.m. on May 15”, the number of people is “4”, and the price per person is “8,000 yen”, the management device 3 posts, for example, information including reservation spaces corresponding to the number of people who can use the target for use and prices respectively set for the reservation spaces of the number of people (flat sum of 8,000 yen in this example) on the Internet 1, as shown in FIG. 5. As a result, the members can recognize that the solicitation for the reservations of the target for use is made.

After making the solicitation for the reservations of the target for use, the management device 3 sends a solicitation response, showing that the solicitation is started, back to the golf course server 4, as shown in FIG. 4.

### 2-2. Hosting Application

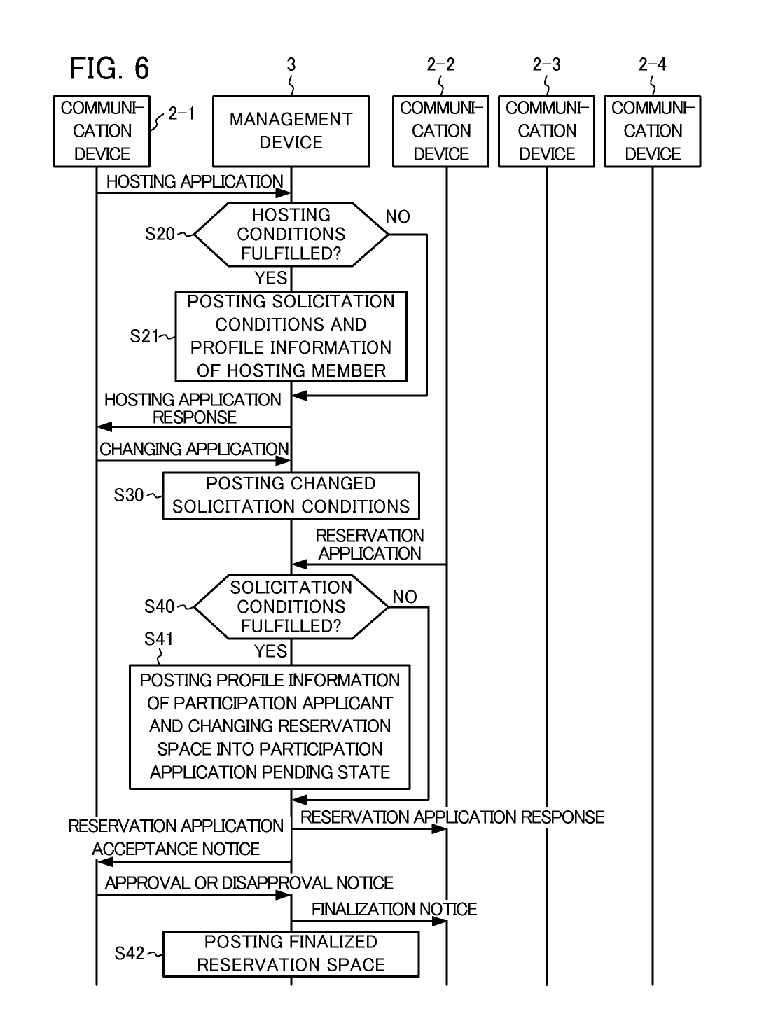

Next, the operation of the reservation support system 100 with regard to the hosting application will be explained with reference to FIG. 6. The hosting application means that a member offers to host the solicitation for the reservations of the target for use. It is possible for the members of the SNS who are registered in the management device 3 in advance to offer the hosting application. More specifically, when the member who offers to be the host specifies one of the plural reservation spaces shown in FIG. 5 (e.g., selects one of the “reservation spaces” buttons), a hosting application page is displayed on the communication device of the member. When the member inputs necessary information and makes confirmation, the information regarding the hosting application is transmitted from the communication device to the management device 3. In the example shown in FIG. 6, the information regarding the hosting application is transmitted from the communication device 2-1 to the management device 3. The hosting application includes hosting application information showing the member ID of the member offering to be the host, and solicitation conditions.

The solicitation conditions are conditions to be set by the member offering to be the host with regard to the solicitation for the reservations of the target for use, which can be set for each of the reservation spaces. In the example shown in FIG. 5, one of the four reservation spaces is specified by the member offering to be the host, so that the solicitation conditions can be set for the three other reservation spaces.

The explanation will be made with reference to FIG. 6 again. When receiving the hosting application, the management device 3 determines whether or not hosting conditions are fulfilled (S20). The hosting conditions are set in advance in operating the management device 3. The conditions may include, for example, the evaluation value of 100 or more, the playing history of three years or more, the owner of the membership right, or the like. In this case, the CPU 30 of the management device 3 reads out the profile information elements that correspond to the member ID included in the hosting application information from the member database DB, and determines whether or not the hosting conditions are fulfilled. Thus, it is possible to prevent members not satisfying a certain standard, such as a member having a low rating or a member not having much golf experience, from hosting the solicitation for the reservations of a reservation target. As a result, the quality in operating the reservation support system can be improved. In the following explanation, the member whose hosting application is accepted by the management device 3 is referred to as a hosting member.

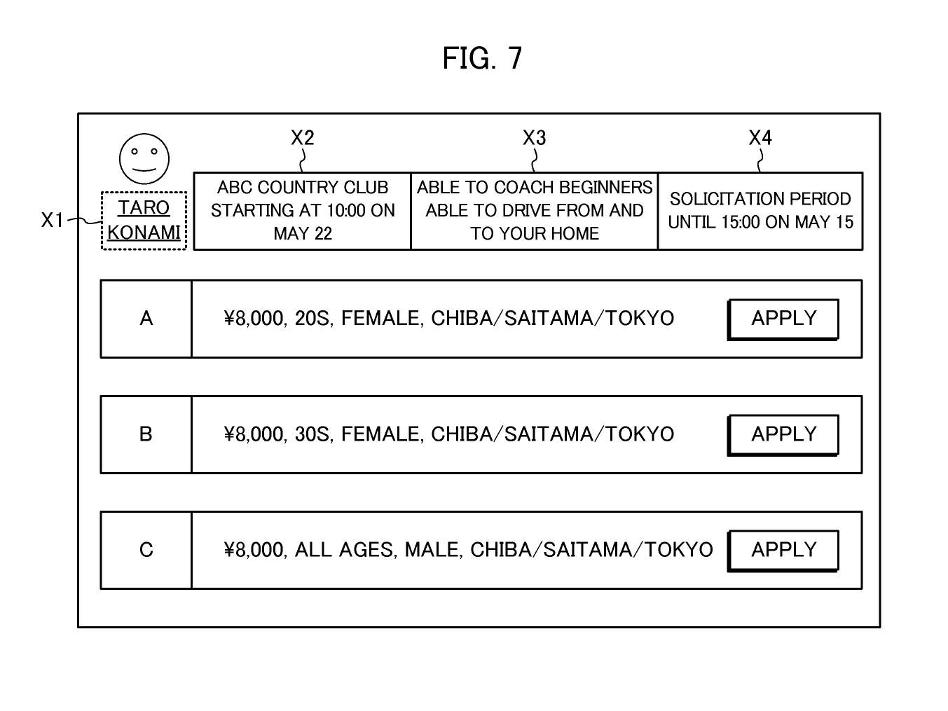

After that, the management device 3 posts the solicitation conditions included in the hosting application information and the profile information of the hosting member corresponding to the member ID included in the hosting application information on the Internet 1 (S21). A solicitation page posted on the Internet 1 is shown in FIG. 7. A region X1 displays the name of the hosting member, a region X2 displays the golf course and the date and time, a region X3 displays a message from the hosting member, and a region X4 displays a solicitation period.

In addition, a price, age, gender, and an address are independently set for each of the reservation spaces A to C. For example, the solicitation targeted for a woman in her twenties is made in the reservation space A, whereas the solicitation targeted for a man of any age is made in the reservation space C. As the hosting member can set the solicitation conditions like this, it is possible to hold a golf competition by the members intended by the hosting member.

When clicking on the region X1, there is a transition to a public page of the hosting member (Taro Konami, in this example) of the SNS. A profile and comments of the hosting member are displayed on the public page. It is possible for a member considering to reserve the target for use to consider whether or not to participate in the target for use after learning the profile of the hosting member by referring to the public page of the hosting member.

After that, the management device 3 sends a hosting application response, showing whether or not the hosting application is accepted, back to the communication device 2-1 of the member who offers the hosting application. As a result, it is possible for the member who offers to be the host to recognize whether or not the hosting is accepted.

### 2-3. Changing Application

Subsequently, the changing application will be explained. The hosting member can change the solicitation conditions at any time during the solicitation period. However, it is not possible to change the solicitation conditions of the reservation space to which a reservation application is made, as will be described later. In the example shown in FIG. 6, the changing application is transmitted from the communication device 2-1 to the management device 3. The changing application includes changing application information showing changed solicitation conditions. The changed solicitation conditions include a price, age, gender, an address and the like.

When receiving the changing application during the solicitation period, the management device 3 posts the changed solicitation conditions on the Internet 1 based on the changing application information (S30). As a result, the members can learn the latest solicitation conditions. Meanwhile, the management device 3 does not accept the changing application made after the end of the solicitation period.

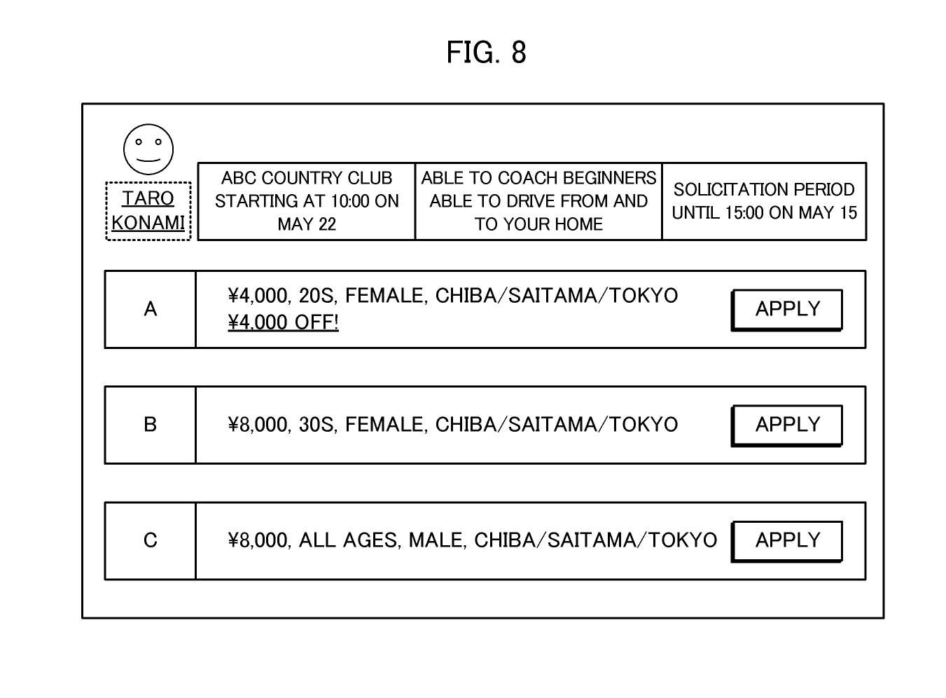

When, for example, the price of the reservation space A is reduced by 4,000 yen according to the changed solicitation conditions, the price of the reservation space A is changed from 8,000 yen to 4,000 yen, and “¥4,000 OFF!” is displayed, as shown in FIG. 8. In this case, 4,000 yen for the member in the reservation space A is additionally charged to the hosting member. The charging may be made in such a way that the hosting member pays 12,000 yen, as the price of 8,000 yen added with 4,000 yen, at the time of the payment at the golf course.

Alternatively, it is also possible to purchase electronic points worth 4,000 yen and to use the points to make the payment. In this case, the members of the SNS may access a predetermined page generated by the management device 3 to purchase the electronic points. The points owned by the member may be associated with the member ID and stored in the member database DB. It is possible for the member to use the points to make payment of the amount corresponding to the number of points. In this example, the hosting member pays the points worth 4,000 yen to the management device 3, out of the points purchased in advance. The management device 3 manages the paid points and, when the reservation of the target for use is finalized, performs settlement processing with the golf course server 4. As the payment can be made by the electronic points, flexibility in the settlement processing can be improved. Meanwhile, when the reservation of the target for use is not made, the points may be paid back to the hosting member. When the electronic points are used, it is possible to make it a condition for accepting the changing application that the hosting member pays the electronic points corresponding to the reduction amount of the price. The changed solicitation conditions may not be posted when the changing application is not accepted, and the changed solicitation conditions may be posted only when the changing application is accepted. The electronic points to be paid with the changing application may not necessarily be purchased in advance, but may be purchased at the time when the payment is required.

As described above, since the price change or the like by the hosting member during the solicitation period of the reservations of the target for use is permitted, it is possible to facilitate the finalizing of the reservations of the target for use. In other words, it is possible to promote participation of other members by reducing the price, when the solicitation period draws to an end.

In contrast, it is also possible to increase the price. For example, the price for the reservation space C targeted for a male may be increased, and the price for the reservation space A targeted for a female may be reduced.

When the changing application to reduce or increase the price of another reservation space is made by the hosting member, the CPU 30 in the management device 3 changes the price for the hosting member while keeping the sum total of the prices for all the reservation spaces of the target for use constant. When, for example, the changing application to reduce the price for another reservation space is made by the hosting member, the price corresponding to the reduced amount will be charged to the hosting member. Thus, the solicitation conditions for the reservations of the target for use may be freely changed without forcing a provider of the target for use to bear the burden.

In the example shown in FIG. 8, the base price for each reservation space is a flat sum of 8,000 yen, and the sum total is 32,000 yen. When the price of the reservation space A is reduced to 4,000 yen, the hosting member needs to pay 12,000 yen, as the price for the hosting member is set so that the sum total remains constant.

### 2-4. Reservation Application

Next, the reservation application will be explained. The reservation application means that another member offers to reserve the target for use in which the hosting member hosts solicitation for the reservations. In the example shown in FIG. 6, the reservation application is transmitted from the communication device 2-2 to the management device 3. The reservation application includes reservation application information including the member ID of the member who offers to reserve the reservation space. Specifically, when the member selects an “Apply” button in each of the reservation spaces A to C, as shown in FIG. 8, the reservation application information including the member ID is transmitted from the communication device 2-2 to the management device 3.

When receiving the reservation application, the management device 3 determines whether or not the solicitation conditions are fulfilled (S40). In this determination processing, the management device 3 reads out profile information that corresponds to the member ID included in the reservation application from the member database DB, and determines whether or not the read-out profile information fulfills the solicitation conditions.

For example, it is assumed that the member having the member ID “0004” shown in FIG. 3 selects the “Apply” button in the reservation space C. As “Male” and “Chiba/Saitama/Tokyo” are set as the solicitation conditions in the reservation space C, the solicitation conditions are not fulfilled. In contrast, when the member having the member ID “0002” shown in FIG. 3 selects the “Apply” button in the reservation space C, the solicitation conditions are fulfilled.

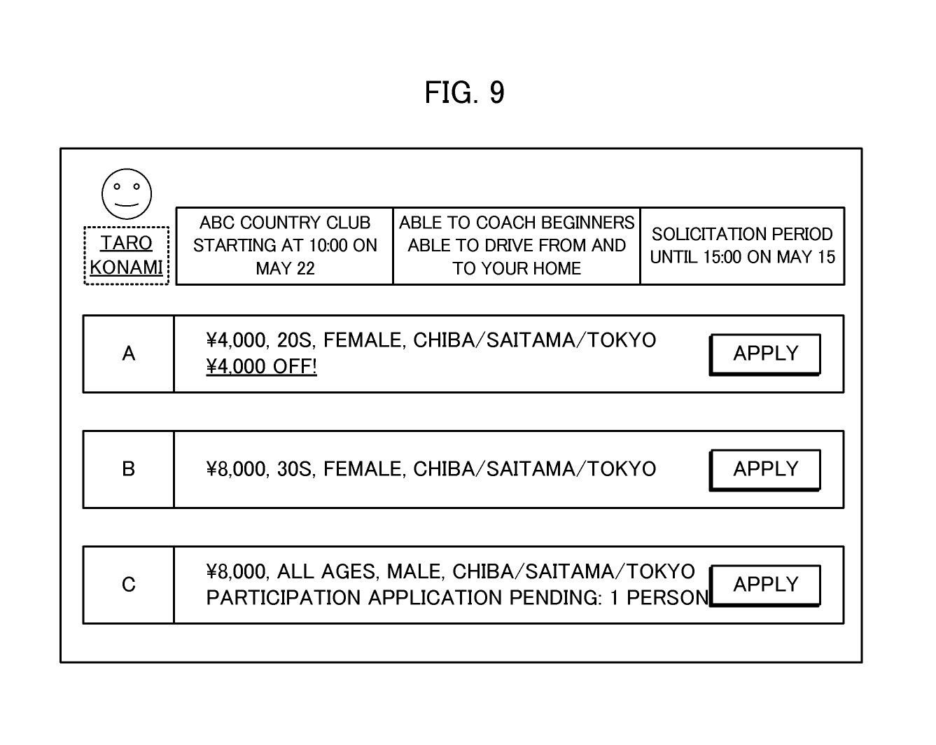

When the solicitation conditions are fulfilled, the management device 3 accepts the reservation application, posts the profile of the participation applicant, and changes the state of the reservation space into a participation application pending state (S41). For example, when the reservation space C receives the reservation application, “Participation application pending” is displayed in the reservation space C as shown in FIG. 9. Other members can make reservation applications to the reservation space C under this state because, in this example, it is the hosting member that approves one of the plural received reservation applications in the end.

The explanation will be made with reference to FIG. 6 again. When the processing in the steps S40 and S41 are completed, the management device 3 sends a reservation application response back to the communication device 2-2. This reservation application response includes information showing whether or not the reservation application is received. When the solicitation conditions are fulfilled, the reservation application is accepted. When the solicitation conditions are not fulfilled, the reservation application is not accepted.

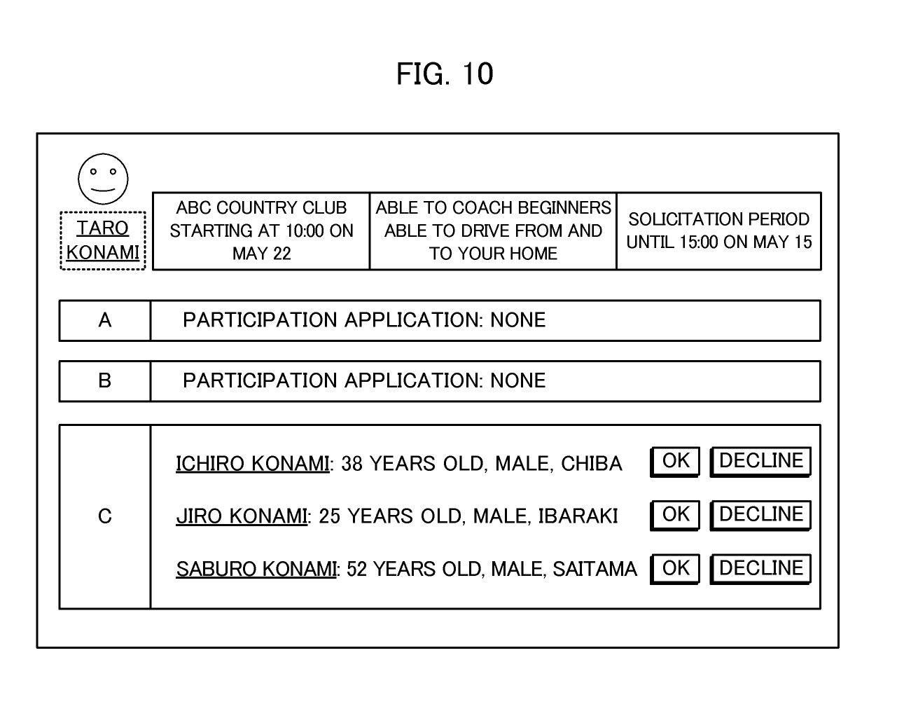

When the reservation application is accepted, the management device 3 transmits a reservation application acceptance notice to the communication device 2-1 of the hosting member. By receiving the reservation application acceptance notice, the acceptance of the reservation application is recognized in the communication device 2-1. As described above, it is the hosting member that determines whether or not the accepted reservation application is approved in the end. It is possible for the hosting member to browse a management page of the target for use in which the hosting member hosts the solicitation for the reservations as shown in FIG. 10. This management page is provided by the management device 3 to the communication device 2-1. In this example, it is assumed that the reservation applications from the three members are accepted for the reservation space C. When the hosting member selects the name displayed in the reservation space C in the communication device 2-1, a page of the member whose reservation application is accepted is displayed, and the profile of the member can be browsed. As a result, it is possible for the hosting member to consider the member to play golf with, after learning the profile of the member whose reservation application is accepted.

When either an “OK” button or a “Decline” button in the reservation space C is selected, an approval or disapproval notice shown in FIG. 6 is transmitted from the communication device 2-1 to the management device 3. Selecting the “OK” button for one member means that the “Decline” buttons are automatically selected for other members.

As described above, the hosting member can select the types of members the hosting member desires, since the right to approve the reservation application is given to the hosting member.

When receiving the approval or disapproval notice, the management device 3 transmits finalization notice to the communication device of the member whose reservation application is accepted. The finalization notice includes information showing whether or not the reservation application is approved. As a result, it is possible for the member who offers the reservation application to know whether or not the reservation application is approved. It should be noted that the notification is not made to the member to whom the non-acceptance is notified in the reservation application response.

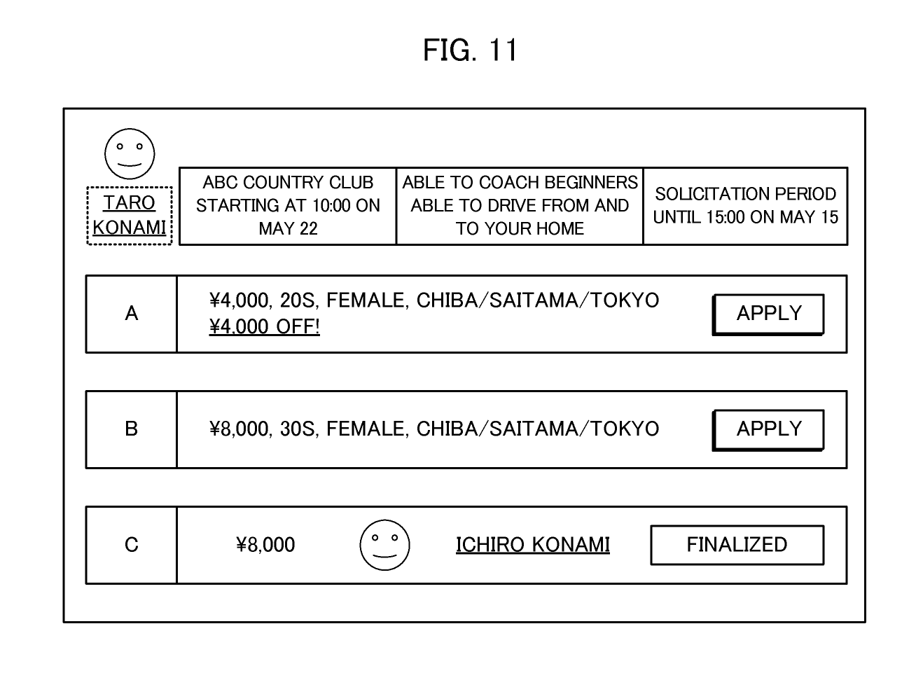

After that, the management device 3 posts the reservation space whose reservation is made (S42). For example, when the hosting member selects the “OK” button corresponding to “Ichiro Konami” in the management page shown in FIG. 10, the management device 3 updates the solicitation page of the reservation of the target for use, as shown in FIG. 11. A member considering the reservation can browse a public page of “Ichiro Konami” by selecting “Ichiro Konami” in the reservation space C. As a result, it is possible to know the personality of the participant whose reservation is made.

### 2-5. Price Reducing Application

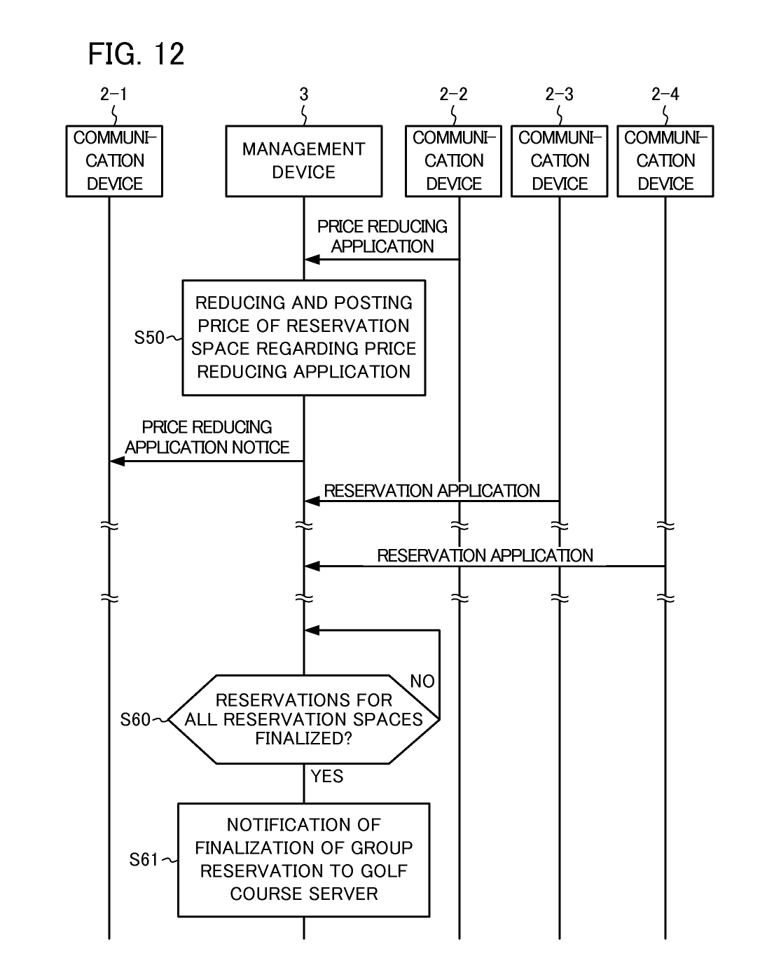

Subsequently, the price reducing application will be explained with reference to FIG. 12. The member whose reservation application is approved (hereinafter referred to as a participating member) can make the price reducing application for the reservation space that is not reserved yet. In the example shown in FIG. 12, the price reducing application is transmitted from the communication device 2-2 to the management device 3. The price reducing application includes price reducing application information including the member ID, the specified reservation space, and the reduction amount of the price.

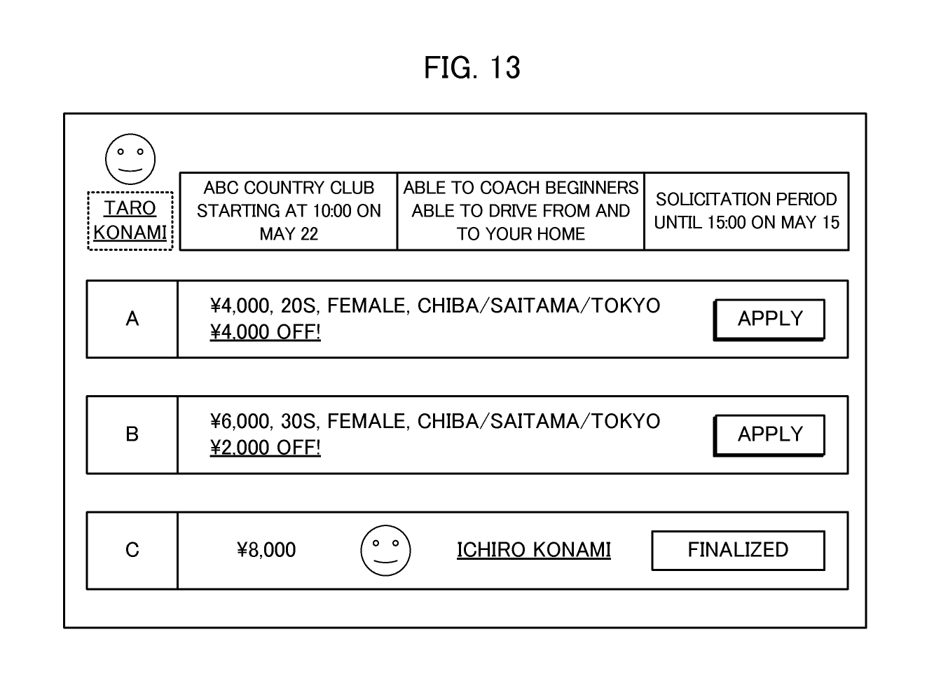

When receiving the price reducing application, the management device 3 determines whether or not it is from the member whose reservation application is approved based on the member ID. When it is from the member whose reservation application is approved, the management device 3 reduces the price of the reservation space regarding the price reducing application by the amount shown in the price reducing application information, and posts the updated solicitation page (S50). After that, when the received price reducing application is from “Ichiro Konami” who is the participating member and is to reduce the price for the reservation space B by 2,000 yen, the solicitation page is updated as shown in FIG. 13. Specifically, the price for the reservation space B is changed from 8,000 yen to 6,000 yen, and “¥2,000 OFF!” is displayed. In this case, 2,000 yen for a member who reserves the reservation space B is additionally charged to the participating member who makes the price reducing application. The charging may be made in such a way that the participating member who makes the price reducing application pays 10,000 yen, as the price of 8,000 yen added with 2,000 yen, at the time of the payment at the golf course.

Alternatively, it is also possible to purchase the electronic points worth 2,000 yen and to use the points to make the payment, similarly to the changing application. In this example, the member who makes the price reducing application pays the points worth 2,000 yen to the management device 3, out of the points purchased in advance. The management device 3 manages the paid points and, when the reservation of the target for use is made, performs the settlement processing with the golf course server 4. As a result, it is possible not only for the hosting member, but also for the member whose reservation application is approved, to make the price reduction for the reservation space that is not reserved yet, which increases the probability that a group reservation of the target for use will finally be completed. Meanwhile, when the reservation of the target for use is not made, the points may be paid back to the hosting member whose price reducing application is approved. When the electronic points are used, it is possible to make it a condition for accepting the price reducing application that the hosting member pays the electronic points corresponding to the reduction amount of the price. The changed price may not be posted when the price reducing application is not accepted, and the changed price may be posted only when the price reducing application is accepted. The electronic points to be paid with the price reducing application may not necessarily be purchased in advance, but may be purchased at the time when the payment is required.

Since not only the hosting member but also the participating member are allowed to make the price reduction as described above, it is possible to promote the participation of members of modest means, and to allow the reservation of the target for use to become effective more easily. However, it is not possible for the participating member to make an application to increase the price, and to change other solicitation conditions.

### 2-6. Group Reservation Finalization Notice

Subsequently, a group reservation finalization notice will be explained with reference to FIG. 12. In this example, it is assumed that reservation applications are transmitted to the management device 3 from the communication device 2-3 for the reservation space A, and from the communication device 2-4 for the reservation space B, and that both of the reservation applications are approved.

The management device 3 determines whether or not the reservations of all the reservation spaces are made until the end of the solicitation period (S60). When the reservations of all the reservation spaces are made, the management device 3 transmits the group reservation finalization notice showing that the group reservation is made to the golf course server 4 (S61). As a result, the golf course server 4 can recognize that the group reservation is made.

As described above, according to the reservation support system of this embodiment, the hosting member can freely set the solicitation conditions for the reservation spaces, other than the reservation space reserved by the hosting himself or herself, at the time when the hosting application is made. In addition, the hosting member can freely change the solicitation conditions at any time after the hosting application is accepted. As described above, the hosting member can freely set and change the solicitation conditions for the reservation of the target for use, which increases the probability that the group reservation of the target for use will finalized.

In particular, as long as it is within the solicitation period, the hosting member can change the price for the reservation space that is not reserved yet, in consideration of an application status of the reservation, even after the solicitation conditions are set once. As a result, it is possible to reduce the price when the solicitation period draws to an end, for example, so as to promote the participation of other members, and to further increase the probability that the group reservation of the target for use will be finalized.

It is possible not only for the hosting member, but also for the participating member whose reservation application is approved, to make the price reduction for the reservation space that is not reserved yet. As a result, the probability that the group reservation of the target for use will be finalized can be further increased.

Since the member considering the reservation application can learn the profiles of the hosting member and the participating member by using the function of the SNS, the reservation of the target for use can be made with ease. Therefore, the probability that the group reservation of the target for use will be finalized can be further increased.

### 3. Modification Example

The present invention is not limited to the above-described embodiment, and it can be modified as follows, for example. One or more aspects that are freely selected from the following exemplifications can be combined as necessary.

(1) According to the above-described embodiment, the management device 3 is provided separately from the golf course server 4. However, the present invention is not limited to the above, and the management device 3 and the golf course server 4 may be integrally provided.

(2) According to the above-described embodiment, the management device 3 accepts the hosting application when the hosting conditions are fulfilled (S20). However, the present invention is not limited to the above, and it may not be necessary to provide the hosting conditions. Furthermore, the membership of the SNS may be set as a requirement for the host.

(3) According to the above-described embodiment, the management device 3 determines whether or not the solicitation conditions are fulfilled (S40) when receiving the reservation application, and accepts the reservation application only when the conditions are fulfilled. However, the present invention is not limited to the above, and all the reservation applications from the members may be accepted until the reservations of the reservation spaces are made, and the hosting member may determine whether or not the reservation applications are approved. Furthermore, when receiving the reservation application, the management device 3 may determine whether or not the solicitation conditions are fulfilled (S40) and may approve the reservation application when the conditions are fulfilled. Alternatively, when receiving the reservation application, the management device 3 may approve the reservation application by receiving the reservation application without determining the solicitation conditions. In other words, the approval by the hosting member is not essential in approving the reservation application, and the management device 3 may approve the reservation application autonomously.

### REFERENCE SIGNS LIST

1 . . . The Internet
2-1 to 2-n . . . Communication devices
3 . . . Management device
4 . . . Golf course server
DB . . . Database

1. A management device to provide information to solicit reservations of a target for use that is jointly used by plural members via a communication network, and to finalize the reservations as one group reservation by receiving plural applications with regard to the reservations of the target for use made by the plural members, comprising:
a solicitation information providing unit that provides via the communication network reservation space information including plural reservation spaces corresponding to a number of people who can use the target for use and price information elements respectively set for the plural reservation spaces;
a hosting application accepting unit that, when accepting a hosting application by receiving hosting application information showing the hosting application offering to host solicitation for the reservations of the target for use from a communication device of the member, changes the reservation space which is specified by the hosting application information and which is in a non-reserved state into a reserved state as a host reservation space;
a price changing unit that, when accepting a changing application by receiving changing application information showing the changing application to change the price set for the reservation space from the communication device of a hosting member who is a member whose hosting application is accepted, updates the price information element set for the reservation space in the non-reserved state, according to the price information element specified by the changing application information;
a reservation application accepting unit that, when approving a reservation application by receiving reservation application information showing the reservation application offering to reserve the target for use from the communication device of the member, changes the reservation space which is specified by the reservation application information and which is in the non-reserved state into the reserved state; and
a reservation finalizing unit that, when all the reservation spaces are in the reserved state, finalizes the reservations as one group reservation.

2. The management device according to claim 1,
wherein, when accepting the changing application of the hosting member to reduce or increase the price for the reservation space in the non-reserved state, the price changing unit changes the price information element of the host reservation space while maintaining a sum total of the prices of all the reservation spaces constant.

3. The management device according to claim 2,
wherein, when the changing application shows that the price for the reservation space in the non-reserved state is reduced, the price changing unit makes it a condition for accepting the changing application that the hosting member pays electronic points corresponding to a reduction amount of the price.

4. The management device according to claim 2,
wherein, when accepting a price reducing application by receiving price reducing application information showing the price reducing application to reduce the price set for the reservation space in the non-reserved state by a predetermined amount from the member whose reservation application is approved, the price changing unit reduces by the predetermined amount the price information element set for the reservation space which is specified by the price reducing application information and which is in the non-reserved state, and increases by the predetermined amount the price information element set for the reservation space which is reserved by the member whose reservation application is approved.

5. The management device according to claim 4,
wherein the price changing unit makes it a condition for accepting the price reducing application that electronic points corresponding to the predetermined amount are paid.

6. The management device according to claim 1,
wherein the changing application information or the price reducing application information independently specifies the price information element corresponding to the reservation space which is in the non-reserved state included in the reservation space information, and
the price changing unit changes the price information element corresponding to the reservation space which is independently specified.

7. The management device according to claim 1,
wherein the hosting application information or the changing application information includes solicitation conditions of the reservation spaces in the non-reserved state, and the solicitation information providing unit provides the solicitation conditions shown in the hosting application information or the changing application information via the communication network.

8. The management device according to claim 1,
wherein the hosting application information includes identification information of the member offering to host the solicitation for the reservations of the target for use,
the reservation application information includes the identification information of the member offering to reserve the target for use, and
the solicitation information providing unit:
reads out profile information associated with the identification information of the hosting member, from a member database in which the identification information identifying the member and the profile information showing a profile of the member are associated with each other and stored, to provide the profile information associated with the host reservation space to the member via the communication network, and
reads out the profile information associated with the identification information of the member whose reservation application is approved from the member database, to provide the profile information associated with the reservation space which is specified by the reservation application information to the member via the communication network.

9. The management device according to claim 8,
wherein the reservation application accepting unit is able to accept plural reservation applications for one reservation space,
the solicitation information providing unit provides the member with the profile information of the member whose reservation application is accepted in association with the reservation space, via the communication network, and
when receiving approval or disapproval information showing approval or disapproval of the reservation application corresponding to the reservation space from the hosting member via the communication network, in a case in which the approval or disapproval information shows that the reservation application is approved, the reservation application accepting unit associates the reservation space only with the reservation application which is approved and changes the reservation space into the reserved state.

10. A management method to provide information to solicit reservations of a target for use that is jointly used by plural members via a communication network, and to finalize the reservations as one group reservation by receiving plural applications with regard to the reservations of the target for use made by the plural members, comprising:
a step of providing via the communication network reservation space information including plural reservation spaces corresponding to a number of people who can use the target for use and price information elements respectively set for the plural reservation spaces;
a step of, when accepting a hosting application by receiving hosting application information showing the hosting application offering to host solicitation for the reservations of the target for use from a communication device of the member, changing the reservation space which is specified by the hosting application information and which is in a non-reserved state into a reserved state as a host reservation space;
a step of, when accepting a changing application by receiving changing application information showing the changing application to change the price set for the reservation space from the communication device of a hosting member who is a member whose hosting application is accepted, updating the price information element set for the reservation space in the non-reserved state, according to the price information element specified by the changing application information;
a step of, when approving a reservation application by receiving reservation application information showing the reservation application offering to reserve the target for use from the communication device of the member, changing the reservation space which is specified by the reservation application information and which is in the non-reserved state into the reserved state; and
a step of, when all the reservation spaces are in the reserved state, finalizing the reservations as one group reservation.
